(19) United States
(12) Patent Application Publication
(10) Pub. No.: US 2025/0308501 A1
(43) Pub. Date: Oct. 2, 2025

(54) ACTIVE VIBRATION NOISE REDUCTION DEVICE

(71) Applicant: HONDA MOTOR CO., LTD., Tokyo (JP)

(72) Inventors: Xun WANG, Wako-shi (JP); Takuma MAESAKA, Wako-shi (JP); Toshio INOUE, Wako-shi (JP)

(21) Appl. No.: 19/062,853

(22) Filed: Feb. 25, 2025

(30) Foreign Application Priority Data
Mar. 27, 2024 (JP) 2024-052501

(51) Int. Cl. G10K 11/178

(52) U.S. Cl. CPC G10K 11/17817; G10K 11/17854; G10K 11/17881

(57) ABSTRACT

An active vibration noise reduction device includes: a speaker for outputting a cancellation sound for canceling a noise, a plurality of microphones each for generating an error signal from the noise and the cancellation sound, and a control filter configured to generate a control signal for controlling the cancellation sound based on the error signals generated by the plurality of microphones. The control filter is adaptively updated using a sum of squares of sound pressures of the error signals generated by the plurality of microphones as an evaluation function.

This application claims foreign priority to Japanese Patent Application No. 2024-052501, filed Mar. 27, 2024, the disclosure of which is incorporated herein by reference in its entirety.

### TECHNICAL FIELD

The present invention relates to an active vibration noise reduction device.

### BACKGROUND ART

Conventionally, active noise reduction devices and the like have been studied that reduce noise by generating a cancellation sound having a phase opposite to that of noise (for example, road noise) generated in a vehicle compartment and causing the generated cancellation sound to interfere with the noise.

For example, a noise control device disclosed in Japanese Patent Application Laid-Open No. H06(1994)-59683 is described in the abstract as “the noise control device is provided with a plurality of microphones for detecting residual sound and outputting it to a plurality of adaptive filters as error signals, a plurality of actuators for reproducing compensation signals output from the plurality of adaptive filters to cancel a noise to form the residual sound, and a plurality of error signal mixing means for dividing the plurality of microphones into a plurality of groups, mixing error signals output from the microphones of each group to form mixed error signals, and outputting the mixed error signals respectively to adaptive filters.

### SUMMARY OF THE INVENTION

### Problems to be Solved by the Invention

For example, when considering application of the noise control device described in Japanese Patent Application Laid-Open No. H06(1994)-59683 to a vehicle, an acoustic mode exists in the vehicle compartment. Therefore, even when the signals acquired by the microphones are added up as error signals, a signal of a certain frequency in the added up signal may be enhanced or canceled. Thus, in the vehicle compartment, the error signal can be controlled when the error signal is enhanced but not controlled when the error signal is canceled.

The present invention has been made in view of the above circumstances, and an object of the present invention is to provide an active noise reduction device capable of stably reducing noise in a wide range by reducing noise at a plurality of control points (microphones).

### Means for Solving the Problems

An aspect of the embodiment of the present invention is an active vibration noise reduction device including: a speaker for outputting a cancellation sound for canceling a noise; a plurality of microphones for generating a plurality of error signals, each of the plurality of microphones generating a respective one of the plurality of error signals from the noise and the cancellation sound; and a control filter configured to generate a control signal for controlling the cancellation sound based on the plurality of error signals generated by the plurality of microphones, wherein the control filter is adaptively updated using a sum of squares of sound pressures of the plurality of error signals generated by the plurality of microphones as an evaluation function.

### Effects of the Invention

According to the present invention, it is possible to stably reduce noise in a wide range by reducing the noise at a plurality of control points (microphones).

### BRIEF DESCRIPTION OF THE DRAWINGS

FIG. 1 is a block diagram illustrating a schematic configuration of an active vibration noise reduction device according to an embodiment.

FIG. 2 is an explanatory diagram illustrating an LMS algorithm for calculating filter coefficients that minimizes an evaluation function.

FIG. 3 is a conceptual diagram illustrating that learning of a plurality of channels is not successful.

FIG. 4 is an explanatory diagram illustrating a concept of setting different initial values in a control filter part;

### DETAILED DESCRIPTION OF EMBODIMENT

Hereinafter, modes for carrying out the present invention (hereinafter referred to embodiments) will be described in detail. The embodiments described below are merely examples for implementing the present invention, and should be appropriately modified or changed depending on the configuration of the device to which the present invention is applied and on various conditions. In the drawings, the same components are denoted by the same reference signs, and the description thereof will be appropriately omitted.

In the present specification, “′” (hat) written together with a reference sign presents an identified value or an estimation value.

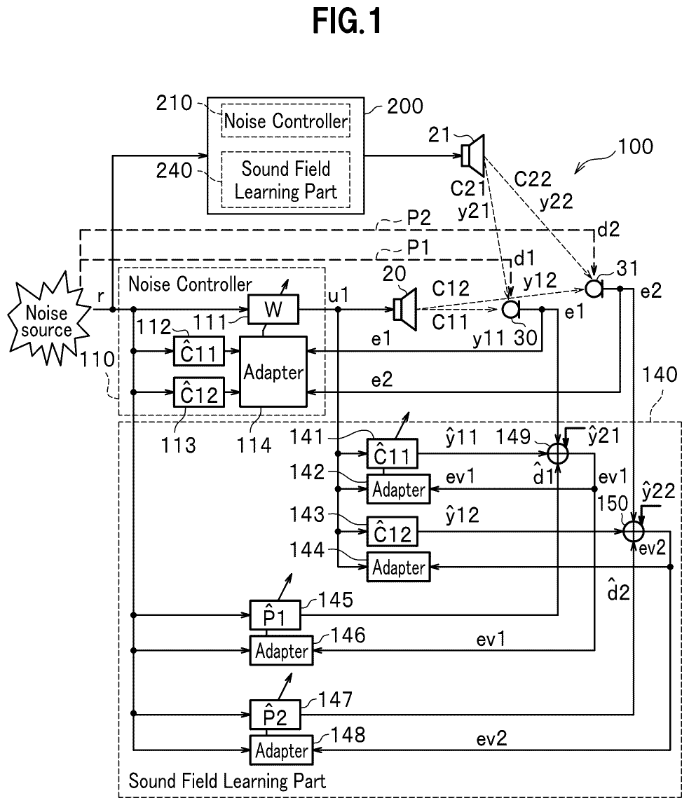

Present Embodiment Schematic Configuration of Active Vibration Noise Reduction Device FIG. 1 is a block diagram illustrating a schematic configuration of an active vibration noise reduction device according to the present embodiment. Active vibration noise reduction devices 100 and 200 illustrated in FIG. 1 each constitute an Active Noise Control (ANC) device for reducing noise generated in a vehicle compartment.

Various noises such as a tire noise, a wind noise, and an engine noise are generated in the vehicle compartment during traveling. An ANC device is provided in the vehicle to cancel a noise generated due to transmission of vibration of the power unit (engine, motor, or the like) or due to the inflow of an exhaust sound or the like, thereby realizing a vehicle with high quietness and creating a comfortable and high-quality space in the vehicle compartment.

That is, the active vibration noise reduction devices 100 and 200 generate cancellation sounds y11, y12, y21, and y22 with phases opposite to those of noises d1 and d2 due to a noise source to cause the generated cancellation sounds y11, y12, y21, and y22 to interfere with the noises d1 and d2, thereby reducing the noises d1 and d2. The noises d1, d2 correspond to, for example, a road noise caused by the wheel vibration due to forces from a road surface. Note that the road noise is an example of the noises d1 and d2. The noises d1 and d2 may be a noise other than the road noise, for example, a driving system noise caused by vibration of a driving source such as an internal combustion engine or an electric motor.

As illustrated in FIG. 1, the active vibration noise reduction device 100 according to the present embodiment includes a noise controller 110, a speaker 20, microphones 30 and 31, and a sound field learning part 140. The active vibration noise reduction device 200 has a configuration equivalent to the active vibration noise reduction device 100 such that a noise controller 210 corresponding to the noise controller 110 and a sound field learning part 240 corresponding to the sound field learning part 140 are included in the active vibration noise reduction device 200. A speaker 21 is connected to the active vibration noise reduction device 200. Note that the active vibration noise reduction device 200 shares the microphones 30 and 31 with the active vibration noise reduction device 100.

The transfer function P1 illustrated in FIG. 1 indicates a noise transmission path and indicates a transfer function of a primary path from the noise source to the microphone 30. The transfer function P2 illustrated in FIG. 1 also indicates a noise transmission path and indicates a transfer function of a primary path from the noise source to the microphone 31.

The transfer function C11 illustrated in FIG. 1 indicates a transfer function of a secondary path from the speaker 20 to the microphone 30, and the transfer function C12 indicates a transfer function of a secondary path from the speaker 20 to the microphone 31. The transfer function C21 illustrated in FIG. 1 indicates a transfer function of a secondary path from the speaker 21 to the microphone 30, and the transfer function C22 indicates a transfer function of a secondary path from the speaker 21 to the microphone 31.

The speaker 20 outputs the cancellation sounds y11 and y12 for canceling the noises d1 and d2. The speaker 20 is provided, for example, in front of the driver's seat or in a door on a lateral side of an occupant seat.

The speaker 21 outputs the cancellation sounds y21 and y22 for canceling the noises d1 and d2. The speaker 21 is provided, for example, in front of the assistant driver's seat or in a door on a lateral side of an occupant seat.

The microphones 30 and 31 generate error signals e1 and e2 from the noises d1 and d2 and the cancellation sounds y11, y12, y21, and y22. The microphone 30 is provided, for example, in a headrest of the driver's seat. The microphone 30 generates the error signal e1 based on the cancellation sound y11 output from the speaker 20, the cancellation sound y21 output from the speaker 21, and the noise d1 at the position of the microphone 30.

On the other hand, the microphone 31 is provided, for example, in a headrest of the assistant driver's seat. The microphone 31 generates the error signal e2 based on the cancellation sound y12 output from the speaker 20, the cancellation sound y22 output from the speaker 21, and the noise \hat{d}2 at the position of the microphone 31.

The noise controller 110 and the sound field learning part 140 are composed of, for example, a computer including an arithmetic processing device (a processor such as a central processing unit (CPU) or a micro processing unit (MPU)) and a storage device (a memory such as a read only memory (ROM) or a random access memory (RAM)). That is, the active vibration noise reduction device 100, except for the speaker 20 and the microphones 30 and 31, may be constructed as a single hardware unit or a unit including a plurality of hardware units, for example.

A reference signal r corresponding to the noises d1 and d2 is input to the noise controller 110. The reference signal r is input to the noise controller 110 from, for example, a reference microphone (not illustrated) that generates the reference signal r from the noises d1 and d2. The noise controller 110 includes a control filter part 111, a first secondary path filter part 112, a second secondary path filter part 113, and a control updater 114.

The control filter part 111 generates a control signal u1 for controlling the cancellation sounds y11 and y12 from the reference signal r. The control signal u1 cancels the noises d1 and d2 by controlling the cancellation sounds y11 and y12. The control filter part 111 is constituted by a control filter W. The control filter W is a finite impulse response (FIR) filter, for example. An FIR filter is a kind of digital filter and is a filter with an impulse response whose continuation duration is finite. In other words, an FIR filter is a filter such that the output signal (impulse response) output when an impulse signal is input converges within a finite time.

The control filter part 111 generates the control signal u1 for controlling the speaker 20 by performing a filtering process on the reference signal r using the control filter W. The control filter part 111 inputs the generated control signal u1 to the speaker 20. The speaker 20 generates the cancellation sounds Y11 and y12 corresponding to the control signal u1 generated by the control filter part 111. The control filter part 111 also inputs the generated control signal u1 to the sound field learning part 140.

The first secondary path filter part 112 is constituted by a secondary path filter Ĉ11 that presents an estimation value of the transfer function Ĉ11 from the speaker 20 to the microphone 30. The secondary path filter Ĉ11 is a filter that presents an estimation value of the transfer function C11 of the secondary path. The secondary path filter Ĉ11 is constituted by an FIR filter, for example.

The first secondary path filter part 112 corrects the reference signal r by filtering the reference signal r using the secondary path filter Ĉ11. The first secondary path filter part 112 inputs the corrected reference signal r to the control updater 114.

The second secondary path filter part 113 is constituted by a secondary path filter Ĉ12 that presents an estimation value of the transfer function Ĉ12 from the speaker 20 to the microphone 31. The secondary path filter Ĉ12 is a filter that presents an estimation value of the transfer function C12 of the secondary path. The secondary path filter Ĉ12 is constituted by an FIR filter, for example.

The second secondary path filter part 113 corrects the reference signal r by filtering the reference signal r using the secondary path filter Ĉ12. The second secondary path filter part 113 inputs the corrected reference signal r to the control updater 114.

The control updater 114 adaptively updates the control filter W of the control filter part 111 using an adaptive algorithm such as Least Mean Square algorithm (LMS algorithm).

Specifically, the control updater 114 adaptively updates the filter coefficients of the control filter W so that the error signals e1 and e2 output from the microphones 30 and 31 are minimized. The control updater 114 adds up the error signals e1 and e2 and performs the adaptive update so as to minimize the sum of them. Note that the control filter W is adaptively updated by the filter coefficients of the control filter W being adaptively updated.

The sound field learning part 140 includes a first cancellation sound estimation signal generator 141, a first secondary path updater 142, a second cancellation sound estimation signal generator 143, and a second secondary path updater 144. The sound field learning part 140 further includes a first noise estimation signal generator 145, a primary path updater 146, a second noise estimation signal generator 147, and a primary path updater 148. The sound field learning part 140 further includes a virtual error signal generators 149 and 150.

The first cancellation sound estimation signal generator 141 is constituted by a secondary path filter Ĉ11. The secondary path filter Ĉ11 of the first cancellation sound estimation signal generator 141 is a filter that has the identical characteristics as the secondary path filter Ĉ11 of the first secondary path filter part 112 to present an estimation value of the transfer function C11 of the secondary path. When the secondary path filter Ĉ11 of the first cancellation sound estimation signal generator 141 is adaptively updated by the below-described first secondary path updater 142, the secondary path filter Ĉ11 of the first secondary path filter part 112 is updated in synchronization to be the same as the secondary path filter Ĉ11 of the first cancellation sound estimation signal generator 141 by the first secondary path updater 142. The secondary path filter Ĉ11 of the first cancellation sound estimation signal generator 141 is constituted by, for example, an FIR filter to be consistent with the secondary path filter Ĉ11 of the first secondary path filter part 112.

The first cancellation sound estimation signal generator 141 generates, by filtering the control signal u1 input from the control filter part 111 of the noise controller 110 by the secondary path filter Ĉ11, a cancellation sound estimation signal ŷ11 that presents an estimation value of the cancellation sound y11. The first cancellation sound estimation signal generator 141 inputs the generated cancellation sound estimation signal ŷ11 to the virtual error signal generator 149.

The first secondary path updater 142 adaptively updates the secondary path filter Ĉ11 of the first cancellation sound estimation signal generator 141 by using an adaptive algorithm such as LMS algorithm and, at the same time, updates the secondary path filter Ĉ11 of the first secondary path filter part 112 to be the same as the secondary path filter Ĉ11 of the first cancellation sound estimation signal generator 141. Specifically, the first secondary path updater 142 adaptively updates the secondary path filters Ĉ11 so that the virtual error signal ev1 input from the virtual error signal generator 149 is minimized.

The second cancellation sound estimation signal generator 143 is constituted by a secondary path filter Ĉ12. The secondary path filter Ĉ12 of the second cancellation sound estimation signal generator 143 is a filter that has the identical characteristics as the secondary path filter Ĉ12 of the second secondary path filter part 113 to present an estimation value of the transfer function C12 of the secondary path. When the secondary path filter Ĉ12 of the second cancellation sound estimation signal generator 143 is adaptively updated by the below-described second secondary path updater 144, the secondary path filter Ĉ12 of the second secondary path filter part 113 is updated in synchronization to be the same as the secondary path filter Ĉ12 of the second cancellation sound estimation signal generator 143 by the second secondary path updater 144. The secondary path filter Ĉ12 of the second cancellation sound estimation signal generator 143 is constituted by, for example, an FIR filter to be consistent with the secondary path filter Ĉ12 of the second secondary path filter part 113.

The second cancellation sound estimation signal generator 143 generates, by filtering the control signal u1 input from the control filter part 111 of the noise controller 110 by the secondary path filter Ĉ12, a cancellation sound estimation signal ŷ12 that presents an estimation value of the cancellation sound y12. The second cancellation sound estimation signal generator 143 inputs the generated cancellation sound estimation signal ŷ12 to the virtual error signal generator 150.

The second secondary path updater 144 adaptively updates the secondary path filter Ĉ12 of the second cancellation sound estimation signal generator 143 by using an adaptive algorithm such as LMS algorithm and, at the same time, updates the secondary path filter Ĉ12 of the second secondary path filter part 113 to be the same as the secondary path filter Ĉ12 of the second cancellation sound estimation signal generator 143. Specifically, the second secondary path updater 144 adaptively updates the secondary path filters Ĉ12 so that a virtual error signal ev2 input from the virtual error signal generator 150 is minimized.

The first noise estimation signal generator 145 is constituted by a primary path filter \hat{P}1. The primary path filter \hat{P}1 is a filter that presents an estimation value of the transfer function P1 of the primary path. The primary path filter \hat{P}1 is constituted by an FIR filter, for example.

The first noise estimation signal generator 145 generates, by filtering the reference signal r using the primary path filter \hat{P}1, a noise estimation signal \hat{d}1 that presents an estimation value of the noise \hat{d}1. The first noise estimation signal generator 145 inputs the generated noise estimation signal \hat{d}1 to the virtual error signal generator 149.

The first primary path updater 146 adaptively updates the primary path filter \hat{P}1 of the first noise estimation signal generator 145 using an adaptive algorithm such as LMS algorithm. Specifically, the first primary path updater 146 adaptively updates the primary path filter \hat{P}1 so that the virtual error signal ev1 input from the virtual error signal generator 149 is minimized.

The second noise estimation signal generator 147 is constituted by a primary path filter \hat{P}2. The primary path filter \hat{P}2 is a filter that presents an estimation value of the transfer function \hat{P}2 of the primary path. The primary path filter \hat{P}2 is constituted by an FIR filter, for example.

The second noise estimation signal generator 147 generates, by filtering the reference signal r using the primary path filter \hat{P}2, a noise estimation signal \hat{d}2 that presents an estimation value of the noise d2. The second noise estimation signal generator 147 inputs the generated noise estimation signal \hat{d}2 to the virtual error signal generator 150.

The second primary path updater 148 adaptively updates the primary path filter \hat{P}2 of the second noise estimation signal generator 147 using an adaptive algorithm such as LMS algorithm. Specifically, the second primary path updater 148 adaptively updates the primary path filter \hat{P}2 so that the virtual error signal ev2 input from the virtual error signal generator 150 is minimized.

The virtual error signal generator 149 is constituted by an adder. The virtual error signal generator 149 generates a virtual error signal ev1 by adding up the error signal e1 input from the microphone 30, the cancellation sound estimation signal ŷ11 input from the first cancellation sound estimation signal generator 141, the noise estimation signal \hat{d}1 input from the first noise estimation signal generator 145, and a cancellation sound estimation signal ŷ21. The virtual error signal generator 149 inputs the generated virtual error signal ev1 to the first secondary path updater 142 and the primary path updater 146. Note that the cancellation sound estimation signal ŷ21 is a cancellation sound estimation signal which is generated by the sound field learning part 240 of the active vibration noise reduction device 200 in the same manner as the first cancellation sound estimation signal generator 141 and which presents an estimation value of the cancellation sound y21.

The virtual error signal generator 150 is constituted by an adder. The virtual error signal generator 150 generates the virtual error signal ev2 by adding up the error signal e2 input from the microphone 31, the cancellation sound estimation signal ŷ12 input from the second cancellation sound estimation signal generator 143, the noise estimation signal \hat{d}2 input from the second noise estimation signal generator 147, and a cancellation sound estimation signal ŷ22. The virtual error signal generator 150 inputs the generated virtual error signal ev2 to the second secondary path updater 144 and the primary path updater 148. Note that the cancellation sound estimation signal ŷ22 is a cancellation sound estimation signal which is generated by the sound field learning part 240 of the active vibration noise reduction device 200 in the same manner as the second cancellation sound estimation signal generator 143 and which presents an estimation value of the cancellation sound y22.

### Update Processing of Active Vibration Noise Reduction Device

Next, a description will be given of update processing of the active vibration noise reduction device 100 according to the present embodiment. The update processing of the active vibration noise reduction device 100 will be described with reference to FIGS. 1 to 3.

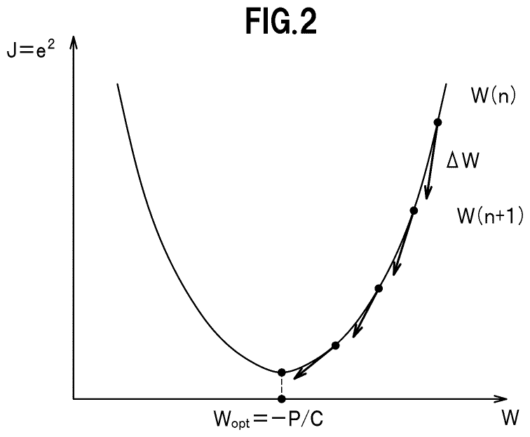

FIG. 2 is an explanatory diagram illustrating an LMS algorithm for calculating filter coefficients that minimize an evaluation function. In the present embodiment, the control filter W is updated by updating the filter coefficients.

In the algorithm shown in FIG. 2, when calculating the filter coefficients that minimizes an evaluation function J (for example, e²), the minimum value is searched for along the negative direction of the gradient of the evaluation function J. When the evaluation function J is minimized, the update amount ΔW is 0. FIG. 2 illustrates that, when the evaluation function J takes the minimum value, the noises d1 and d2 and the error signals e1 and e2 are minimized.

In the present embodiment, the control filter W of the control filter part 111 is adaptively updated using the sum of squares of the sound pressures of the error signals e1 and e2 of the plurality of microphones 30 and 31 as the evaluation function J.

In the acoustic power control, when the evaluation function J is defined as a sum of squares of the sound pressures at positions of the plurality of microphones 30 and 31 (also referred to as control points), the evaluation function J is calculated using the following Formulas (1) to (4).

$$J ( t ) = {\sum }_{m = 1}^{M} {e}_{m}^{2} ( t ) \qquad ( 1 )$$

$${e}_{m} ( t ) = {d}_{m} ( t ) + {\sum }_{s = 1}^{S} {y}_{s , m} ( t ) \qquad ( 2 )$$

$${y}_{s , m} ( r ) = {u}_{s} ( i ) * {C}_{s , m} \qquad ( 3 )$$

$${u}_{s} ( t ) = r ( t ) * {W}_{s} ( t ) \qquad ( 4 )$$

where
t: Discrete time
m: Microphone number
M: Total number of microphones
s: Speaker number
S: Total number of speakers
*: Convolution operation

The present embodiment includes: the secondary path filter Ĉ11 that presents an estimation value of the transfer function from the speaker 20 to the microphone 30; the secondary path filter Ĉ12 that presents an estimation value of the transfer function from the speaker 21 to the microphone 31; and the control filter part 111 whose control filter W is adaptively updated based on the secondary path filters Ĉ11 and Ĉ12.

Therefore, the control filter W is adaptively updated according to the update formulas according to formulas (5) and (6) based on the evaluation function J. Note that, in the following Formulas, m is a fixed value of step size parameter.

$${W}_{s} ( t + 1 ) = {W}_{s} ( t ) - {\sum }_{m = 1}^{M} {μ}_{m} {e}_{m} ( t ) {rc}_{s , m} ( t ) \qquad ( 5 )$$

$${rc}_{s , m} ( t ) = r ( t ) * {\hat{C}}_{s , m} ( t ) \qquad ( 6 )$$

Here, the secondary path filters Ĉ11 and Ĉ12 constituting the control filter W are updated according to the following formulas (7) to (11).

$${\hat{C}}_{s , m} ( t + 1 ) = {\hat{C}}_{s , m} ( t ) + {μ}_{m} {ev}_{m} ( t ) {u}_{s} ( t ) \qquad ( 7 )$$

$${ev}_{m} ( t ) = {e}_{m} - {\hat{d}}_{m} - {\sum }_{s = 1}^{s} {\hat{y}}_{s , m} ( t ) \qquad ( 8 )$$

$${\hat{P}}_{m} ( t + 1 ) = {\hat{P}}_{m} ( t ) + {μ}_{m} {ev}_{m} ( t ) r ( t ) \qquad ( 9 )$$

$${\hat{d}}_{m} ( t ) = r ( t ) * {\hat{P}}_{m} ( t ) \qquad ( 10 )$$

$${\hat{y}}_{s , m} ( t ) = r ( t ) * {W}_{s} ( t ) * {\hat{C}}_{s , m} ( t ) \qquad ( 11 )$$

In order to calculate a value at which the evaluation function J of FIG. 2 is minimized using the above-described Formulas (1) to (4), the following Formula (12) is calculated by performing partial differentiation of Formula (1) with respect to the control filter W, which is unknown.

$$\begin{matrix}\frac{\partial J ( t )}{\partial W} = {\sum }_{m = 1}^{M} 2 {e}_{m} ( t ) \frac{\partial {e}_{m} ( t )}{\partial W} \\ = {\sum }_{m = 1}^{M} 2 {e}_{m} ( t ) ( r ( t ) * {C}_{s , m} )\end{matrix} \qquad ( 12 )$$

The update formula (5) for updating the control filter W can be derived from Formula (12) along the negative gradient of the evaluation function J.

As described above, the active vibration noise reduction device 100 according to the present embodiment includes the speaker 20, the microphones 30 and 31, and the control filter W. The plurality of microphones 30 and 31 are provided, and the control filter W is adaptively updated using the sum of squares of the sound pressures of the error signals e1 and e2 of the microphones 30,31 as the evaluation function J as shown in Formula (1).

According to the above configuration, as the filter coefficients of the control filter W are adaptively updated so that the plurality of error signals e1 and e2 are reduced as shown in FIG. 2 at the same time, the active vibration noise reduction device 100 is capable of reducing the noises \hat{d}1 and \hat{d}2 in a wide range without depending on frequencies.

Therefore, the active vibration noise reduction device 100 according to the present embodiment can perform simultaneous control at a plurality of control points (microphones 30 and 31) even in a closed space such as a vehicle compartment where an acoustic mode is present.

Further, even when a user adjusts the seat position, the control filter W is updated following the change in the seat position (microphones 30 and 31), and thus it is possible to maintain a state in which the noises \hat{d}1 and \hat{d}2 are reduced. In this case, the active vibration noise reduction device 100 is capable of maintaining a state in which the noise is reduced because the secondary path filters Ĉ11 and Ĉ12 are also updated by the sound field learning part 140 following the change in the seat position (microphones 30 and 31).

The active vibration noise reduction device 100 includes secondary path filters Ĉ11 and Ĉ12 that present estimation values of transfer functions Ĉ11 and Ĉ12 from the speaker 20 to the plurality of microphones 30 and 31. For example, as implied by Formulas (5) and (6), the control filter W is adaptively updated based on the plurality of secondary path filters Ĉ11 and Ĉ12.

According to such a configuration, as implied by Formulas (5) and (6), the control filter W of the control filter part 111 is adaptively updated more reliably by the plurality of secondary path filters Ĉ11 and Ĉ12 being adaptively updated.

Further, each of the plurality of secondary path filters Ĉ11 and Ĉ12 may be adaptively updated based on the virtual error signals ev1 and ev2 (virtual error signals) calculated from the error signals e1 and e2 output from the plurality of microphones 30 and 31 corresponding to the cancellation sounds y11, y12, y21, and y22.

According to this configuration, the secondary path filters Ĉ11 and Ĉ12 are adaptively updated through calculation of the virtual error signals ev1 and ev2 calculated from the error signals e1 and e2 as implied by Formulas (7) and (8). With this, the active vibration noise reduction device 100 is capable of enhancing the sound reduction effect by adaptively updating: the secondary path filters Ĉ11 and Ĉ12 of the first cancellation sound estimation signal generator 141 and the second cancellation sound estimation signal generator 143; and the secondary path filters Ĉ11 and Ĉ12 of the first secondary path filter part 112 and the second secondary path filter part 113.

The active vibration noise reduction device 100 is provided with the speaker 20, and the active vibration noise reduction device 200 is provided with the speaker 21. Like this, the secondary path filters Ĉ11, Ĉ12, and not-shown secondary path filters Ĉ21, Ĉ22 may be provided for the combinations between the plurality of speakers 20,21 and the plurality of microphones 30,31. In this case, each of the secondary path filters Ĉ11, Ĉ12, Ĉ21, and Ĉ22 is adaptively updated based on the secondary path filters a for the combinations of the plurality of speakers 20, 21 and the corresponding one of the plurality of microphones 30, 31. For example, the secondary path filter Ĉ11 is updated based on the secondary path filters Ĉ11 and Ĉ21; and the secondary path filter Ĉ12 is updated based on the secondary path filters Ĉ12 and 022.

According to such a configuration, as implied by Formulas (8) and (11), the active vibration noise reduction device 100 is capable of adaptively updating each of the secondary path filters Ĉ11, Ĉ12, Ĉ21, and Ĉ22 based on the secondary path filters C for the combinations of the plurality of speakers 20, 21 and the corresponding one of the plurality of microphones 30, 31. This makes it possible to update the secondary path filters Ĉ11, Ĉ12, Ĉ21, and Ĉ22 more accurately.

Incidentally, it is desirable that the secondary path filters Ĉ11, Ĉ12, Ĉ21, and Ĉ22 are each adaptively updated based on the secondary path filters C for all the combinations of the plurality of speakers 20, 21 and the plurality of microphones 30, 31, i.e., based on the secondary path filters Ĉ11, Ĉ12, Ĉ21, and Ĉ22. By adaptively updating each of the secondary path filters 11, Ĉ12, Ĉ21, and Ĉ22 based on all the secondary path filters Ĉ11, Ĉ12, Ĉ21, and Ĉ22, it is possible to increase the accuracy of sound reduction and to reduce a wide range of noises.

As described above, the speaker 20 is provided for the active vibration noise reduction device 100, and the speaker 21 is provided for the active vibration noise reduction device 200. In this case, the active vibration noise reduction devices 100,200 may each include the control filter W respectively for the speakers 20,21, and the initial values of the control filters W may be different from each other.

According to such a configuration, each control updater 114 sets an initial value to the control filter W so as to shift the first output timing.

Here, for example, if the road noise in a vehicle compartment is to be reduced using vehicle body vibrations detected by acceleration sensors and the same initial value is set for a plurality of control filters W, the control signal of an active vibration noise reduction device is the same as that of other active vibration noise reduction devices.

Therefore, all the secondary path filters Ĉ11, Ĉ12, Ĉ21, and Ĉ22 have the same value, the update formula of Formula (5) also yields the same value, in which case all the update values of the control filters W would be the same value.

That is, as shown in the following Formulas (13) to (18) (in the following Formulas, μ is a fixed value of step size parameter), when the same initial value is set to the control filter W1 (used in the Formula (17)) of the control filter part 111 of the active vibration noise reduction device 100 and the control filter W2 (used in the Formula (18)) of the control filter part of the active vibration noise reduction device 200, the control signal u1 of the active vibration noise reduction device 100 and the control signal u2 of the active vibration noise reduction device 200 would have the same value. Therefore, even if the control filters W1 and W2 of the active vibration noise reduction devices 100, 200 are updated, the secondary path filters Ĉ11, Ĉ12, Ĉ21, and Ĉ22 would have the same values.

$$\hat{C} 11 ( t + 1 ) = \hat{C} 11 ( t ) + μ ev 1 ( t ) u 1 ( t ) \qquad ( 13 )$$

$$\hat{C} 12 ( t + 1 ) = \hat{C} 12 ( t ) + μ ev 2 ( t ) u 1 ( t ) \qquad ( 14 )$$

$$\hat{C} 21 ( t + 1 ) = \hat{C} 21 ( t ) + μ ev 1 ( t ) u 2 ( t ) \qquad ( 15 )$$

$$\hat{C} 22 ( t + 1 ) = \hat{C} 22 ( t ) + μ ev 2 ( t ) u 2 ( t ) \qquad ( 16 )$$

$$u 1 ( t ) = r ( t ) * W 1 ( t ) \qquad ( 17 )$$

$$u 2 ( t ) = r ( t ) * W 2 ( t ) \qquad ( 18 )$$

Therefore, as shown in Formulas (19) to (24), even if the control filter W1 of the active vibration noise reduction device 100 and the control filter W2 of the active vibration noise reduction device 200 are updated by rc11, rc12, rc21, and rc22 shown in Formula (6) calculated respectively by the secondary path filters Ĉ11, Ĉ12, Ĉ21, and Ĉ22 having the same value, the control filters W1 and W2 would have the same value.

$$W 1 ( t + 1 ) = W 1 ( t ) - μ ( e 1 ( t ) rc 11 ( t ) + e 2 ( t ) rc 12 ( t ) ) \qquad ( 19 )$$

$$W 2 ( t + 1 ) = W 2 ( t ) - μ ( e 1 ( t ) rc 21 ( t ) + e 2 ( t ) rc 22 ( t ) ) \qquad ( 20 )$$

$$rc 11 ( t ) = r ( t ) * \hat{C} 11 ( t ) \qquad ( 21 )$$

$$rc 12 ( t ) = r ( t ) * \hat{C} 12 ( t ) \qquad ( 22 )$$

$$rc 21 ( t ) = r ( t ) * \hat{C} 21 ( t ) \qquad ( 23 )$$

$$rc 22 ( r ) = r ( t ) * \hat{C} 22 ( t ) \qquad ( 24 )$$

As a result, in the next control cycle, the control signal u1 of the active vibration noise reduction device 100 and the control signal u2 of the active vibration noise reduction device 200 remain at the same value. That means, the two speakers 20, 21 output the same cancellation sounds y11, y12, y21, and y22.

As described above, even when the control filter W of the active vibration noise reduction device 100 and the control filter W of the active vibration noise reduction device 200 are updated, the filter coefficients have the same value, and the same cancellation sound is output from the two speakers 20, 21.

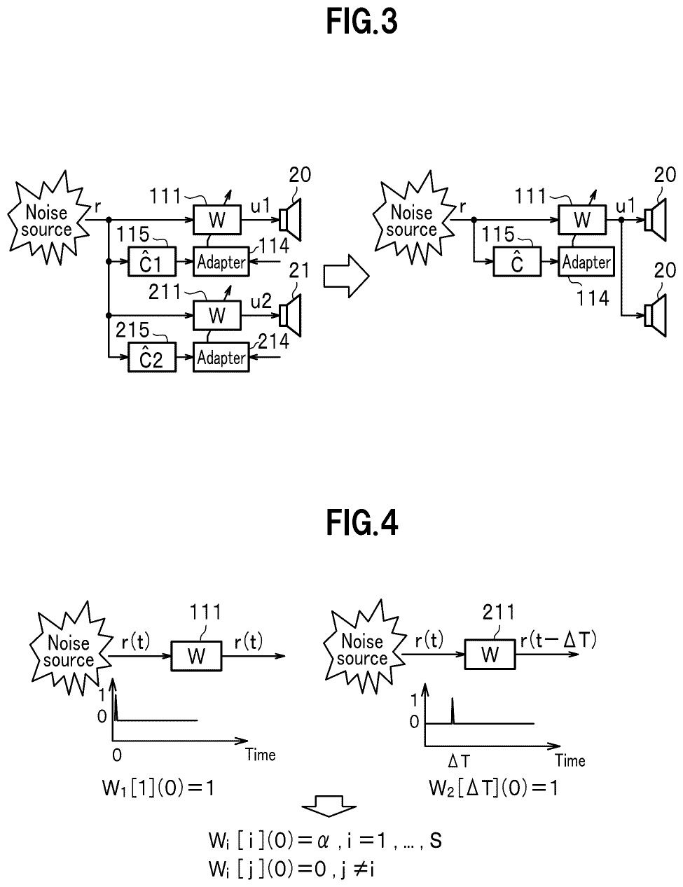

FIG. 3 is a conceptual diagram showing that learning of a plurality of channels (a plurality of speakers 20,21) is not successful. As shown in FIG. 3, the control signal u1 generated by the control filter W of the control filter part 111 has the same value as the control signal u2 generated by the control filter W of the control filter part 211. In this case, the secondary path filter Ĉ1 of the secondary path filter part 115 has the same value as the secondary path filter Ĉ2 of the secondary path filter part 215.

The result is as the same as a case where two speakers 20 are driven in parallel with only one control signal u1 generated by the control filter W of the control filter part 111. This is substantially the same as a case where only one control channel is provided.

In view of this, it is conceivable to configure the active vibration noise reduction device 100,200 to adjust the output timing by setting the initial values of the control filters W of the control filter part 111,211 to different values thereby to generate uncorrelated control sounds (cancellation sounds).

FIG. 4 is an explanatory diagram illustrating the concept of setting different initial values in the control filter parts. As illustrated in FIG. 4, the control filter part 111 and the control filter part 211 are set with initial values at different times.

The control updater 114 (FIG. 1) sets an initial value to the control filter part 111 at a predetermined timing t, and the control updater 214 (FIG. 3) sets an initial value to the control filter part 211 at a time with a delay of ΔT to the predetermined timing t.

As a result, as illustrated in FIG. 4, the outputs of the control filter part 111 and the control filter part 211 are signals shifted by the time ΔT. As a result, as the road noise is a broadband noise, by shifting the timing of the initial values, it is possible to produce uncorrelated outputs.

For example, an initial value a is set for an i-th element of the i-th control filter part 111, and a value of 0 is set to the other elements.

$${W}_{i} [ i ] ( 0 ) = α , i = 1 , … , S \qquad ( 25 )$$

$${W}_{i} [ i ] ( 0 ) = 0 , j \neq i \qquad ( 26 )$$

Similarly, an initial value a is set to a j-th element, which is different from the i-th element of the i-th control filter part 211, and a value of 0 is set to the other elements.

According to Formulas (25) and (26), the control filter W of the first control filter part 111 outputs a control signal u1 first, the control filter W of the second control filter part 211 outputs a control signal u2 next, and at last, the S-th control filter part outputs a control signal. In this way, the control signals u1 and u2 can be made different by shifting the output timing of the control channels.

As a result, the secondary path filters Ĉ1 and Ĉ2 of the secondary path filter parts 115, 215 illustrated in FIG. 3 are capable of performing learning individually, and thus the control filter part 111 and the control filter part 211 each converge to correct values. Therefore, the active vibration noise reduction devices 100, 200 are capable of performing learning for the secondary path filters Ĉ1 and Ĉ2 of the secondary path filter parts 115, 215 even in a case of a plurality of channels.

In this way, the control updaters 114, 214 set the initial value a to the control filters W of the control filter parts 111, 211 so that the initial output timing is shifted by ΔT to prevent the same control sound (cancellation sound) from being output from the two speakers 20, 21.

The active vibration noise reduction devices 100 and 200 may share the primary path filters \hat{P}1 and \hat{P}2 representing the transfer functions \hat{P}1 and \hat{P}2 from the noise source to the plurality of microphones 30, 31 and may adaptively update the common primary path filters \hat{P}1 and \hat{P}2 with respect to the control of the plurality of speakers 20, 21.

With this configuration, according to Formula (9), by handling the plurality of outputs (noises \hat{d}1 and \hat{d}2) reaching the plurality of microphones 30, 31 from the noise source in common, it is possible to reduce the amount of calculation by the primary path filter parts \hat{P}1 and \hat{P}2.

The control filter W of the active vibration noise reduction device 100 may generate the control signal u1 for controlling the cancellation sounds y11 and y12 from the reference signal r and may be updated based on a sum of values, each of which is calculated for a respective one of the plurality of microphones 30, 31 and is based on an update amount normalized by the reference signal r and a respective one of the secondary path filters Ĉ11 and Ĉ12, the respective one of the secondary path filters Ĉ11 and Ĉ12 corresponding to the respective one of the plurality of microphones 30, 31.

The active vibration noise reduction device 100 needs to cause many filters to learn during the control by the sound field-learning type acoustic power control. In this case, the noise reduction effect cannot be obtained unless all the filters (primary path filters \hat{P}1 and \hat{P}2 and secondary path filters Ĉ11 and Ĉ12) converge. Therefore, it is desirable that the learning speed of all the filters of the active vibration noise reduction device 100 be improved.

Calculation formulas for normalizing the update amount of each filter coefficient based on the input signal will be described using Formulas (27) to (29).

$${W}_{s} ( t + 1 ) = {W}_{s} ( t ) - {\sum }_{m = 1}^{M} \frac{{μ}_{m}}{‖ {rc}_{s , m} ( t ) ‖ + σ} {e}_{m} ( t ) {rc}_{s , m} ( t ) \qquad ( 27 )$$

$${\hat{C}}_{s , m} ( t + 1 ) = {\hat{C}}_{s , m} ( t ) + \frac{{μ}_{m}}{‖ r ( t ) ‖ + ‖ {u}_{s} ( t ) ‖ + σ} {ev}_{m} ( t ) {u}_{s} ( t ) \qquad ( 28 )$$

$${\hat{P}}_{m} ( t + 1 ) = {\hat{P}}_{m} ( t ) + \frac{{μ}_{m}}{‖ r ( t ) ‖ + ‖ {u}_{s} ( t ) ‖ + σ} {ev}_{m} ( t ) r ( t ) \qquad ( 29 )$$

where
σ: Small positive number
∥•∥: Norm of signal vector
μₘ: Fixed value of step size parameter

According to this configuration, the active vibration noise reduction device 100 can improve the convergence speed by normalizing the update amount of each filter coefficient by the norm of the signal vector based on the input signal as shown in Formulas (27) to (29). The active vibration noise reduction device 100 normalizes each term of the summation during the update of the control filter W. In particular, as shown in Formula (27), as the learning amount for each of the microphones 30 and 31 is normalized, the convergence speed can be improved.

In this way, the convergence speed of the entire control by the active vibration noise reduction device 100 is improved by normalizing the update amount of each of the plurality of microphones 30,31.

Note that, in the description of the present embodiment, FIR filters are used as the control filter W, the primary path filters \hat{P}1 and \hat{P}2, the secondary path filters Ĉ11, Ĉ12, Ĉ21, and Ĉ22, and the like. However, the present embodiment is not limited to the FIR filters and another kind of filter (e.g., a single-frequency adaptive notch filter) can be applied as appropriate.

1. An active vibration noise reduction device comprising:
a speaker for outputting a cancellation sound for canceling a noise;
a plurality of microphones for generating a plurality of error signals, each of the plurality of microphones generating a respective one of the plurality of error signals from the noise and the cancellation sound; and
a control filter configured to generate a control signal for controlling the cancellation sound based on the plurality of error signals generated by the plurality of microphones,
wherein the control filter is adaptively updated using a sum of squares of sound pressures of the plurality of error signals generated by the plurality of microphones as an evaluation function.

2. The active vibration noise reduction device according to claim 1, further comprising:
a plurality of secondary path filters each configured to present an estimation value of a transfer function from the speaker to a respective one of the plurality of microphones,
wherein the control filter is adaptively updated further based on the plurality of secondary path filters.

3. The active vibration noise reduction device according to claim 2,
wherein each of the plurality of secondary path filters is adaptively updated based on a virtual error signal calculated from the cancellation sound and the error signal output from a respective one of the plurality of microphones.

4. An active vibration noise reduction device comprising:
a plurality of speakers for outputting a plurality of cancellation sounds for canceling a noise, each of the plurality of speakers generating a respective one of the plurality of cancellation sounds;
a plurality of microphones for generating a plurality of error signals, each of the plurality of microphones generating a respective one of the plurality of error signals from the noise and the plurality of cancellation sounds;
a plurality of control filters each provided for a respective one of the plurality of speakers and each configured to generate, based on the plurality of error signals generated by the plurality of microphones, a control signal for controlling the cancellation sound to be output from the respective one of the plurality of speakers; and
a plurality of secondary path filter groups each provided for a respective one of the plurality of control filters and including a plurality of secondary path filters, the plurality of secondary path filters each configured to present an estimation value of a transfer function from a respective one of the plurality of speakers to a respective one of the plurality of microphones,
wherein the plurality of control filters are each adaptively updated based on the corresponding plurality of secondary path filters, using a sum of squares of sound pressures of the plurality of error signals generated by the plurality of microphones as an evaluation function, and
wherein each of the plurality of secondary path filters is adaptively updated based on a virtual error signal calculated from the plurality of cancellation sounds and the error signal output from a respective one of the plurality of microphones.

5. The active vibration noise reduction device according to claim 4,
wherein each of the plurality of secondary path filters of each of the plurality of secondary path filter groups is adaptively updated based on, among the plurality of secondary path filters, secondary path filters for combinations between the plurality speakers and a respective one of the plurality of microphones.

6. The active vibration noise reduction device according to claim 4,
wherein initial values of the plurality of control filters are different from one another.

7. The active vibration noise reduction device according to claim 5, further comprising:
a plurality of primary path filters each configured to present an estimation value of a transfer function from a noise source to a respective one of the plurality of microphones,
wherein the plurality of primary path filters are each shared for control for the plurality of speakers and are each adaptively updated in common with respect to the control of the plurality of speakers.

8. The active vibration noise reduction device according to claim 2,
wherein the control filter is configured to generate the control signal for controlling the cancellation sound from a reference signal and to be updated with a sum of values, each of which is calculated for a respective one of the plurality of microphones and is based on an update amount normalized by the reference signal and a respective one of the plurality of secondary path filters, the respective one of the plurality of secondary path filters corresponding to the respective one of the plurality of microphones.
